(19) United States
(12) Patent Application Publication
(10) Pub. No.: US 2008/0008439 A1
(43) Pub. Date: Jan. 10, 2008

(54) Method and System For Dynamic Management Of Multiple Media Data Streams

(76) Inventors: Guangqun Liu, Los Gatos, CA (US); Jun Chen, Shanghai (CN)

Correspondence Address: ORRICK, HERRINGTON & SUTCLIFFE, LLP;IP PROSECUTION DEPARTMENT, 4 PARK PLAZA, SUITE 1600, IRVINE, CA, 92614-2558, US

(21) Appl. No.: 11/758,915

(22) Filed: Jun. 6, 2007

Related U.S. Application Data
(60) Provisional application No. 60/866,794, filed on Nov. 21, 2006.

(30) Foreign Application Priority Data
Jul. 7, 2006 (CN) 200610027335.8

(51) Int. Cl. H04N 5/91

(52) U.S. Cl. 386/46

(57) ABSTRACT

An improved system and method for playing multiple media streams is disclosed. Unlike traditional sequential streaming methods where the source outputs media streams in a fixed sequential relationship, the improved system may play a media stream at any time during another media stream. In addition, a float layer on the media stream permits a user to activate (e.g., by clicking a mouse) events such as a popup window containing a website, another media, an advertisement and the like.

### CROSS-REFERENCE TO RELATED APPLICATIONS

This patent application claims priority to U.S. provisional patent application Ser. No. 60/866,794, filed on Nov. 21, 2006, and patent application Ser. No. 60/866,794, filed in the People's Republic of China on Jun. 7, 2006, the entirety of which is incorporated herein by reference. This patent application is a continuation-in-part to patent application Serial no. 200610027335.8, filed in the People's Republic of China on Jun. 7, 2006.

### FIELD OF THE INVENTION

The field of the invention relates to a method and system for dynamic management of multiple media streams.

### BACKGROUND OF THE INVENTION

The internet has a coverage that may exceed that of traditional media, and its reach is expanding daily. Ten years ago, 60˜70% of the internet traffic on major public websites such as Yahoo! and MSN was from within the U.S. Today, 60˜70% of the traffic comes from overseas. This steadily increasing reach of the Internet to more diverse cultures has been accompanied by a transition from static textual information to more interactive multimedia applications. In particular, multimedia streaming—where video, sound, images and text are sent in real time over the Internet to subscribers—is one of the growth areas driving Internet usage today.

Multimedia streaming on the internet has many uses, including but not limited to, watching movies online, watching live news coverage, listening to sports events, and advertising. The commonly used streaming method packages movies, news, and advertisements in sequence at the streaming source. The publisher or advertiser does not have sufficient flexibility to change the pre-sequenced media stream after it leaves the streaming source. It is particularly inflexible with respect to internet advertising, where advertisers would like to tailor advertising towards individual countries, locations, or even individual computers and mobile devices.

Internet advertising has unrivalled potential for relevance and interactivity when compared with traditional advertising. However, internet advertising is still in its infancy. Internet advertisers have not been able to take full advantage of the internet's natural superiority; particularly in streaming video advertisements. The current method of combining advertisements and video programs in a sequential fashion at the streaming source has many disadvantages. These include poor user experience due to long loading time when one media stream is switched to another, an inability to control the frequency with which a user views each advertisement, and an inability for advertisers to target advertisements to specific users and to take advantage of internet statistics. One cause of these disadvantages is the limited flexibility available in streaming media content formats. Therefore, there is a need for improved flexibility in controlling streaming media content. In addition, the current method of combining advertisements and video programs permits insufficient dynamic user interaction. For example, see http://www.theeggnetwork.com/options/addemo/. As shown in this web link, while a user may click on a float layer on a video clip to interrupt the video clip in order to play another video clip and then return to the original video clip, the streaming mechanism is limited because it uses a traditional sequential streaming method and both the original and second video clips must be in the flash media format.

A new method is described in this patent specification that allows businesses and advertisers to tailor advertisement frequency and content after the media streams have left the streaming source to overcome the disadvantages of the existing methods.

### BRIEF DESCRIPTION OF THE DRAWINGS

The accompanying drawings, which are included as part of the present specification, illustrate the preferred embodiments of the present invention, and together with the general description given above and the detailed description of the preferred embodiment given below, serve to explain and teach the principles of the present invention. The components in the drawings are not necessarily to scale, emphasis instead being placed upon illustrating the principles of the invention. Moreover, in the drawings, reference numerals designate corresponding parts throughout the different views. However, like parts do not always have like reference numerals. Moreover, all illustrations are intended to convey concepts, where relative sizes, shapes and other detailed attributes may be illustrated schematically rather than literally or precisely. The system described below may incorporate one or more of FIGS. 1 to 5.

FIG. 1 illustrates a block diagram of an exemplary system for managing multiple media streams, according to one embodiment;

FIG. 2 illustrates a flow diagram of an exemplary process by which a client computing device obtains a copy of the Master Control Module from a carrier of the module, according to one embodiment;

FIGS. 3A and 3B illustrate a flow diagram of an exemplary process of managing multiple media streams, where the media streams and the floating layer on the media streams have portions that a user can activate to cause an action or event, according to one embodiment;

FIG. 4A illustrates a flow diagram of an exemplary process for managing multiple media streams, where two or more pre-arranged media streams are played by multiple media players, according to one embodiment;

FIG. 4B illustrates a flow diagram of an exemplary process for managing multiple media streams, where one or more of the media streams is live, according to one embodiment; and

FIG. 5 illustrates a display monitor showing an example of a media stream being played on a window as well as one or more float layers.

### SUMMARY OF THE INVENTION

The present invention relates to a method and system of managing multiple media streams after the streams have left the streaming source(s). In addition to the traditional method of streaming different media contents sequentially, the system also may allow multiple media streams to be streamed at the same time. Instead of being limited to playing the sequentially formatted media stream on a single player, the improved system may allow multiple streams to be played through multiple separate media or virtual media players. The system of the preferred embodiment chooses to present one of the many media streams to the viewer, while buffering or pausing the other media stream(s) at the same time. Moreover, the system optionally enables float layer on top of the streaming media, and portions of the float layer and/or the media stream on which it overlays have actionable portions, meaning that a user may cause an action or event to occur by interacting with the actionable portion of the float layer and/or the media stream. Finally, the system may choose one or more of the many previously created contents to be shown in a float layer that is overlaid on top of a particular media stream.

### DETAILED DESCRIPTION OF THE PREFERRED EMBODIMENTS

A method and system for managing multiple media streams are described. In the following description, for purposes of explanation, specific nomenclature is set forth to provide a thorough understanding of the various inventive concepts disclosed herein. However, it will be apparent to one skilled in the art that these specific details may not be required in order to practice the various inventive concepts disclosed herein.

The present invention also relates to an apparatus for performing the inventive method. This apparatus may be specially constructed for the required purposes, or it may comprise a general-purpose computer selectively activated or reconfigured by a computer program stored in the computer. Such a computer program may be stored in a computer readable storage medium, including but not limited to, any type of disk including floppy disks, optical disks, CD-ROMs, flash drives, and magnetic-optical disks, read-only memories, random access memories, EPROMs, EEPROMs, magnetic or optical cards, or any type of media suitable for storing electronic instructions, and each coupled to a computer system bus.

The methods presented herein are not limited for use on any particular computer or apparatus. Various general-purpose systems may be used with software programs written in accordance with the teachings herein, or it may prove convenient to construct a more specialized apparatus to perform the required method. The required structure for a variety of these systems is provided in the patent specification. In addition, the present invention is not described with reference to any particular programming language. It will be appreciated that a variety of programming languages may be used to implement the teachings of the invention as described herein, such as Java, C++, etc.

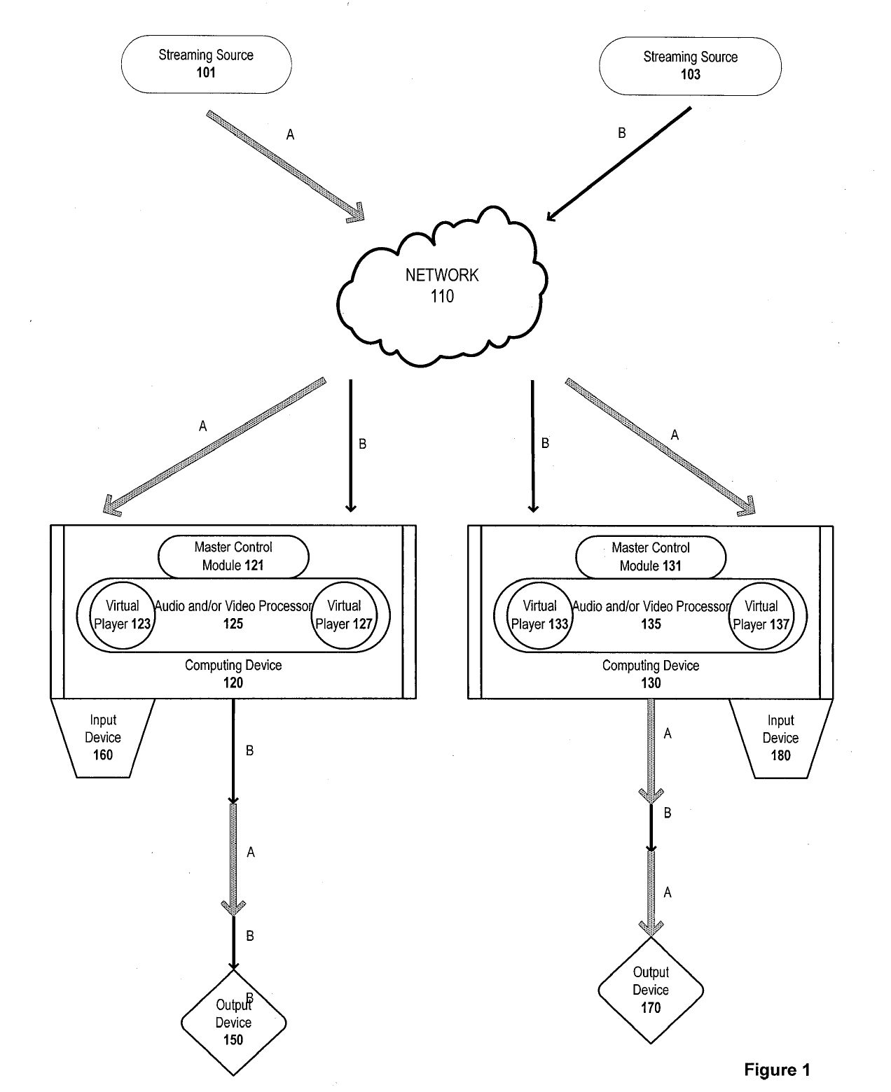

FIG. 1 illustrates a block diagram of an exemplary system of managing multiple media streams, according to one embodiment. Streaming sources 101 and 103 are different origins of streaming media. Streaming media may be streaming audio, streaming video, or a combination of streaming audio and video data. For simplicity, only two sets of streaming sources, media streams, client computing devices, and media players etc. are depicted in the figures, although the system may include more than two streaming sources, media streams, media players, etc. Streaming sources may be similar in characteristics or very different. For example, streaming source 101 and 103 may be two different servers containing multimedia data, such public or private website servers. In another embodiment, streaming source 101 may be a CD-ROM or any other media storage device while streaming source 103 may be a server providing downloadable video or audio clips. In yet another embodiment, a float layer source 105 provides a file containing the contents to be shown in a float layer that is overlaid on top of any of the media streams. Similar to streaming sources, a float layer source 105 may be a server or any other media storage device. A float layer source 105 and a streaming source (101 or 103) may reside on the same physical structure or separate physical structures. For example, they may reside on the same or different servers.

Similarly, the media data from streaming sources may be in same or different formats. For example, streaming source 101 may provide streaming of a video advertisement (stream A) and streaming source 103 may provide streaming of a movie (stream B). As another example, streaming source 101 may provide streaming of an audio broadcast (stream A) and streaming source 103 may stream a live soccer game. As yet another example, streaming source 101 stream a video game (stream A) and streaming source 103 may stream a video on gaming tips (stream B). The format of the audio streams may be, for example, commonly used audio formats of .WAV, .AU, .AIFF, .SND, or any other known audio format. The format of video streams may be, for example, MIDI, .MP3, .M3U, .MPEG-1, .MPEG-2, .MPEG-3, .MPEG-4, .MPA, .MPG, .MPV, .MPS, M2V, .M1V, .MPE, .WMV, .AVI, .ASF, .QT, .MOV, .RM, .RA, .RMVB, .FLV, .SWF, 3gp/3gp2, or any other known video format. Preferably, a float layer file is previously created by an advertiser and stored on a float layer source 105. The float layer source 105 may send the float layer file to a media player such as virtual player 123. The float layer file may be in any of the commonly known audio or video formats described above. In the preferred embodiment, the float layer file is in the format of .SWF, .GIF, .RM, .RMVB, or .WMV.

Network 110 is the Internet, alternatively, it may be a Wide Area Network (WAN), a Local Area Network (LAN), or any other system of interconnections enabling two or more devices to exchange information. Further, the network 110 may include a wireless network, such that one or more of the client computing devices may be wireless devices. Streams A and B may be sent to client computing devices over network 110. A float layer file also may be sent to client computer devices via network 110.

In the preferred embodiment, computing devices 120 and 130 are devices that contain memory storage and an audio and/or video processor (125 or 135) that is capable of functioning as multiple virtual players (123, 127, 133, or 137). Audio and/or video processor 125 and 135 may process streaming audio, streaming video, and/or streaming combination of audio and video. For convenience, such an audio and/or video processor is referred to as an audio/video processor.

For example, the computing device may be a desktop computer, server, workstation, television, IP television, Microsoft X-Box, Tivo, and/or audio player. The computing device may also be a mobile device such as a laptop computer, videophone, smart phone, mobile phone, Personal Digital Assistant (PDA), Blackberry by Research In Motion, gaming device such as the Sony Play Station Personal (PSP), or multimedia device such as the Apple Computer iPod, Microsoft Zune, or another similar device.

Two or more computing devices may be included in system 100 and many users can use the system at the same time. Computing devices are connected to input devices (160 or 180), such as a keyboard, keypad, mouse, touch screen, touch pad, or controlling buttons. Similarly, output devices 150 and 170 may be included, such as speakers or display monitors.

The master control module 121 may be implemented by software code and/or hard-coded circuitry. It manipulates the hardware and software available on the computing device to manage multiple media streams. The hardware on the computing device preferably includes at least one audio/video processor.

The script module 129 may reside on one or more of the players (123, 127, 133, or 137). It may be implemented by software code and /or hard-coded circuitry. Utilizing the hardware and software available on the computer device, the script module 129 manages the dynamics of the float layer, such as the location, size, position, and look and feel of the float layer. In the preferred embodiment, the script module 129 and the master control module 121 are in a player and the master control module 121 is in a browser environment that supports Javascript.

Audio/video processors 125 and 135 are capable of converting electronic signals into human perceptible signals such as audio and/or video signals. An audio/video processor can be a microprocessor, microcontroller, graphics controller, video controller, graphics card, sound card, application specific integrated circuit (ASIC), field programmable gate array (FPGA), digital signal processor, parallel processor, or any other known processor capable of processing audio and/or video signals. This audio/video processor preferably is controlled by master control module 121 or 131 in a time multiplexed manner to function as multiple virtual media players (virtual players 123, 127, 133, and 137) for handling multiple media streams. For example, in one embodiment, virtual player 123 plays stream A and virtual player 127 plays stream B, even though both virtual players 123 and 127 are implemented by the same audio/video processor. In one embodiment, the virtual player supports and executes the script module 129.

To reduce the cost of components in the computing device, the master control module 121 or 131 preferably controls a single audio/video processor to behave as multiple virtual media players in order to buffer, pause, and play multiple media streams at the appropriate times so that end users may enjoy a seamless audio/video effect. Multiple virtual players function to manipulate multiple media streams.

In another embodiment, a single computing device may have multiple audio/video processors, where the master control module controls the multiple audio/video processors to handling multiple media streams. In such a case, each of the media players 123, 127, 133 and 137 in the figures would be executed by a separate audio/video processor. As used in this patent specification, the term “virtual player” refer to one of a the multiple virtual players executed by a single audio/video processor, whereas the term “player” encompasses a virtual player and a separate media player in the case of multiple audio/video processors.

The software programs used to facilitate the function of audio/video processor 125 and 135 and master control module 121 and 131 may include or interact with any of the commonly used programs such as Microsoft Windows Media Player, Real Player, Apple Computer's QuickTime, Macromedia Flash Player, or others. The system can play any type of media streams and if desired, may choose the appropriate media player depending on the type of the stream.

Preferably, the script module is a software module. It may be written in a scripting language such as Javascript, vbscript, smil by RealPlayer, asx by Microsoft, Action Script by MacroMedia Flash, URL/Event Script (media service), MEL (Maya Script), MAX Script (3dmax Script), PHP, Asp, Python, CGI, and Perl. It may also be written in other non-scripting languages such as vc, vb, net, Java, Delphi, etc.

System 100 may also include other supporting computing software and hardware, for example, additional webpage servers, databases, microprocessors, and user interface servers.

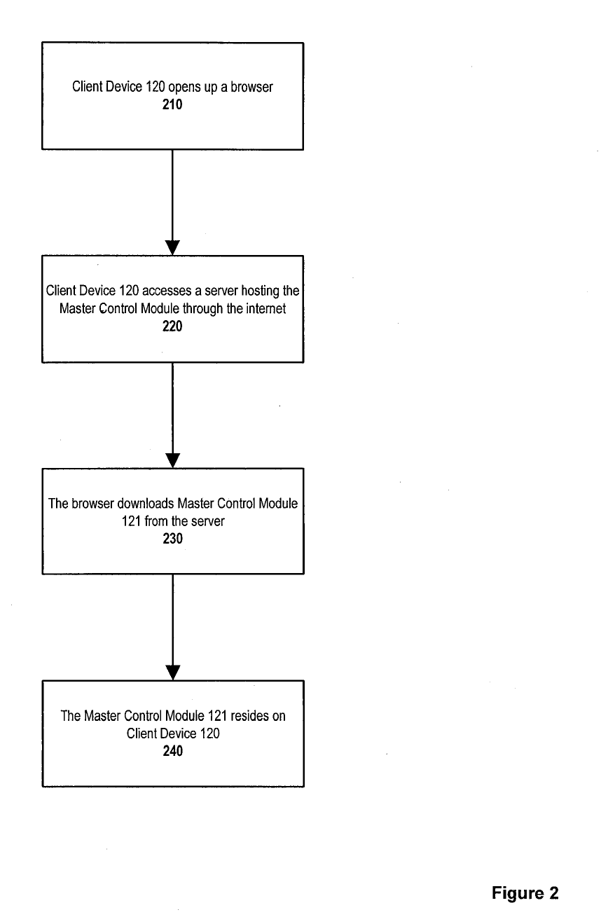

FIG. 2 illustrates a flow diagram of an exemplary process by which a client computing device obtains a copy of the master control module, according to one embodiment. The owner or distributor of the master control module may make it available in different formats, including downloadable software on a server, installable software on a CD-ROM, or in a coded hardware to be installed on any client devices. A person skill in the art understands that many other methods may be used to make the master control module available to the client devices and end users.

If the downloadable software approach is used, the owner may enable it to be downloadable without explicit instruction from the end user. If a client device (130) has a browser with an environment suitable for the master control module to operate, it may access a website hosted on a server of the owner or distributor of the software. The browser may automatically download a copy of the master control module onto a client computing device such as 130. Preferably, the software in the form of a Java script is provided on a web site for download to a client device. The browser may be any web browser that supports JavaScript, such as Microsoft's Internet Explorer, Netscape's browser, Mozilla, Mathon, Firefox, and the Safari browser.

The server that hosts the master control module may be any of the commonly used web servers, such as Apache, Microsoft IIS, Sun Java System Server, and Zeus. It uses any one of a number of protocols and/or applications including HyperText Transfer Protocol (HTTP), File Transfer Protocol (FTP), RTSP, SDP, RTP and RTCP, RSVP, TCP/IP, or other similar connection protocols. The operating system may be any version of Windows® (Windows XP, Mobile, CE, 2000, etc . . . ), Linux, SUN Solaris®, Apple Macintosh OS, Tiger, Nokia Symbian, or other operating systems. In one embodiment, the server is comprised mostly of back-end functionality and no graphical user interface. In another embodiment, the server is a dedicated server. The server uses processing logic, tools and databases and could be built using a combination of technologies such as those from Apache Software (www.apache.org) including Tomcat servers; Java-based technologies such as J2EE, EJB, JBOSS, JDBC; and/or databases such as MySQL. The server may be the VadCast Server operated by CTS Media.

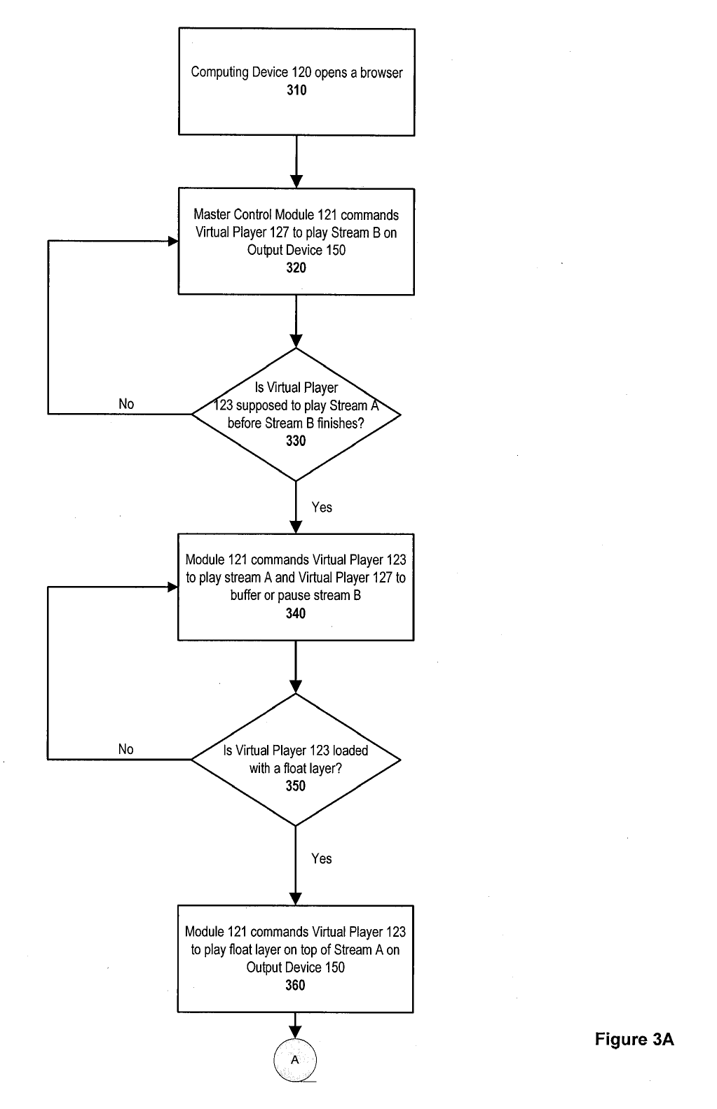

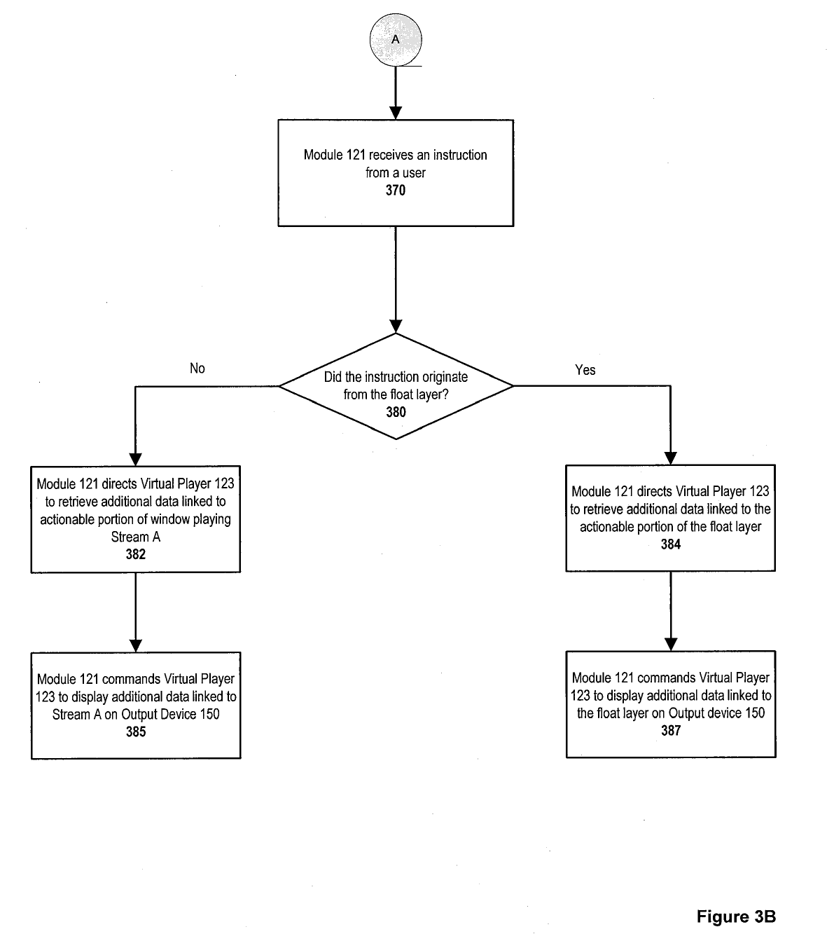

FIGS. 3A and 3B illustrate a flow diagram of an exemplary process of managing multiple media streams, where the media streams and the optional floating layer on the media stream window include portions that are actionable by a user, according to one embodiment. For simplicity, only two media streams, two media players, and one float layer are depicted, although the concept may apply to more than two media streams, more than two media players, and multiple float layers. Because the preferred embodiment time multiplexes an audio/video processor to behave as multiple virtual players, the figures are based on the virtual player concept. The inventive concepts will work on multiple media streams. A person of skill in the art understands that this process may work on two or more media streams. FIGS. 3A and 3B illustrate the example process that permits a media stream A to be inserted into any position in media stream B, as well as the optional actionable portions on a floating layer and media stream.

In step 310, a client computing device 120, e.g., a laptop computer, may open a browser with the master control module 121. In step 320, module 121 sends commands to media player 127 to play stream B on output device 150, such as a display monitor. In step 330, module 121 determines whether stream A should be played before stream B has finished playing. If stream A should not be played before stream B has finished playing, module 121 instructs media player 127 to continue playing stream B, and repeats steps 320 and 330. If stream A should be played before stream B has finished playing, as shown in step 330 and assuming that stream A is ready to be played, module 121 commands media player 123 to play stream A and media player 127 to buffer stream B into a storage medium of any kind in step 340. Alternatively, media player 127 may pause processing of stream A. Assuming that stream A requires a float layer, script module 129 sends a request to float layer source 105 in step 345 for a float layer that corresponds to media stream A; in other words, the request preferably asks for the float layer that was selected in advance to be played on top of media stream A. Script module 129 may send this request via the HTTP protocol. If a float layer is not required, module 121 would skip the remaining steps shown on FIGS. 3A and 3B.

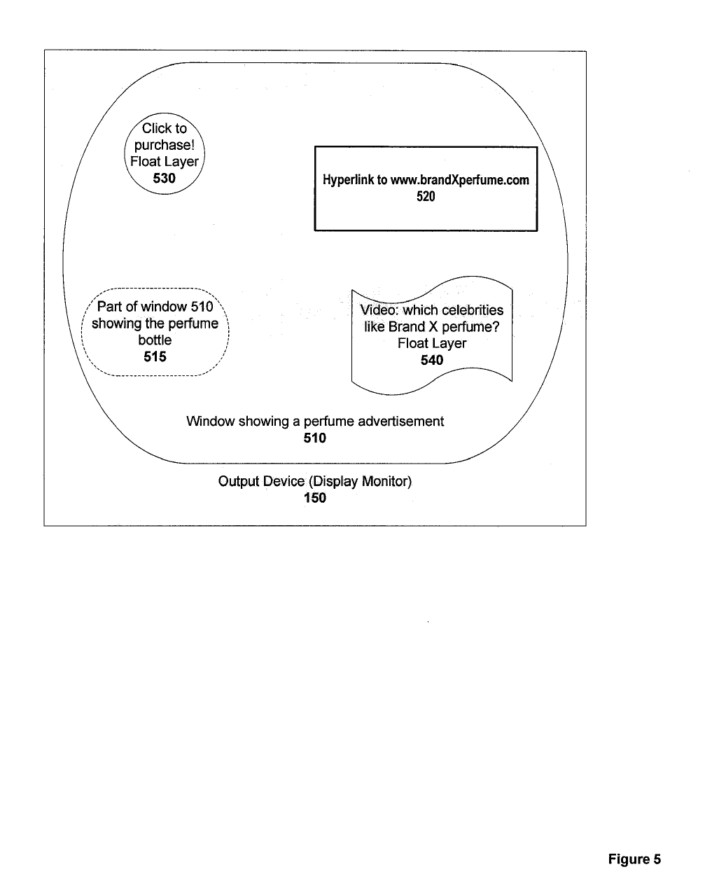

As illustrated in FIG. 5, a float layer refers to a visually perceptible overlay that may appear floating on top of a window 510 playing a video or audio stream. The content of the float layers may be created in advance by advertisers. The float layer content files are stored on servers or media storage devices. The program that defines the dynamic location, size, position, and look and feel of a float layer, such as how the float layer moves dynamically on a media stream, as well as the program that makes the float layer activatable, delineates the triggering event (e.g., cursor movement, mouse click, etc.), and defines the triggered action may be created in advance and incorporated into the float layer file. Known programming methods may be used in order to creating the float layer or a display area that is activatable by events such as movement of a mouse or other user pointing device. The content of the float layer may contain information relating to an advertisement that is being streamed, and may be in the format of a logo, text, image(s) of a product, animation segment, video clip, hyperlink, etc.

On a display monitor 150, a float layer may look to the user like a secondary window or a bubble embedded in a primary window 510. After script module 129 sends a request to float layer source 105 for a float layer corresponding to media stream A, float layer source 105 sends a float layer file via HTTP protocol and script module 129 sends the received float layer file to media player 123, as shown in step 350. Script module 129 then commands media player 123 to play the received float layer information in the window on top of stream A that is still being played, as shown in step 360. In addition to allowing a user to trigger actions by interacting with the float layer, the user may also trigger actions by interacting with predetermined portions of the window that is playing media stream A. Such an action of the user generates an instruction, software interrupt, or hardware interrupt to script module 129. Script module 129 is capable of detecting user events such as the position and movement of the mouse, depression of a button, etc. Script module 129 determines whether the user event or instruction came from the float layer, as shown in step 380. If the answer is yes, script module 129 directs media player 123 to execute the action or event (e.g., popup order form) associated with the activated portion of the float layer and display the relevant responsive information on the output device 150, as shown in steps 384 and 387. If the instruction came from an activated portion of the media stream window instead of the float layer, script module 129 directs media player 123 to perform the same steps in executing the selected action or event with respect to media stream A, as shown in steps 382 and 385.

Numerous types of float layers are envisioned. For example, window 510 on computer monitor 150 may stream a video advertisement for brand X perfume, where there are one or more float layers on top of the advertisement media stream at any time. An example float layer 530 may have text stating “Click to Purchase” so that a user may click this text with a mouse or other device and be directed to an internet purchase form. Another float layer 520 may be in the format of a hyperlink to bring up the product website in another window for more information about the perfume. As still another example, a perfume bottle 515 is shown as part of the advertisement media stream in window 510. A transparent float layer 515 may be overlaid onto the perfume bottle, or the perfume bottle may be made activatable, so a user's action on the perfume bottle or the transparent float layer 515 directs the user to the perfume's product website. Yet another float layer 540 may be a small window showing a video clip of celebrities discussing how much they like brand X perfume. Optionally, if the user clicks on the float layer 540, the window containing the video clip may expand to show the video clip in full screen. Preferably, the content of the float layer is created in advance, but the size, location, movement, and look and feel of the float layer on a media stream are controlled by instructions in the script module 129.

In one embodiment, many float layer files were created previously and stored on a server or other media storage devices. Master control module 121 directs script module 129 to obtain the appropriate float layer corresponding to a particular media stream. For example, when media stream A is an advertisement for brand X perfume, an appropriate float layer may be in the shape of a brand X perfume bottle, which if activated by a user, may display additional information about brand X perfume. A float layer that leads to a competing brand of perfume or dog food may not be appropriate for a media stream A playing an advertisement for brand X perfume. The selection of the appropriate float layer may be performed by a human in advance by programming the script module 129 to know which float layer corresponds to a particular media stream and then when a float layer is needed, the script module 129 sends a request to the float layer source 105 for the corresponding float layer file(s). The float layer source 105 sends the matching float layer file(s) to player 123 on the client computing device via the HTTP protocol. Alternatively, the script module 129 may be programmed to look at tags and codes identifying the content of the media stream A and select a corresponding float layer based on the tags and codes of the float layer.

In another embodiment, both the float layer and the media stream window on which the float layer appears, are actionable or have activatable portions, meaning that a user may cause an action or event to occur by interacting with the activatable portion of the float layer and/or the activatable portion of the media stream window. The script module 129 is capable of detecting any user events, such as a click on a portion of the float layer, e.g., a logo, button, or hyperlink floating on the main streaming media window. In response, the browser will execute the preprogrammed action or event, such as displaying additional information about the product being advertised or displaying an order form on a website to enable the user to make a purchase. Alternatively, rolling a cursor over the actionable portion of the float layer by using a mouse, touch screen, track ball, arrow keys, buttons, or other user controllable device, may initiate the same action. In another embodiment, the activatable portion of the media stream or a float layer may permit a user to view the advertisement again either immediately or after a certain period of time by clicking e.g., a button floating on the streaming media window. The button may also be used for a user to show that he or she does not want to see a particular advertisement again. This permits users to have more control over their viewing of advertisement and the advertiser learns statistics about the popularity of a particular advertisement and more information on the success of advertisements targeting a particular user.

In the alternative, only one virtual player is required to play media streams A and B. At step 330, module 121 directs virtual player 127 to play stream B. When stream B finishes playing, the same media player 127 may play stream A. Optionally, the sequential streaming method and the multiple media player streaming method may co-exist and operate on the same system. The master control module determines whether to use one or both methods depending on the requirement of the client devices, the purpose of the publisher or the advertiser, or the content of the media streams, or some other factor.

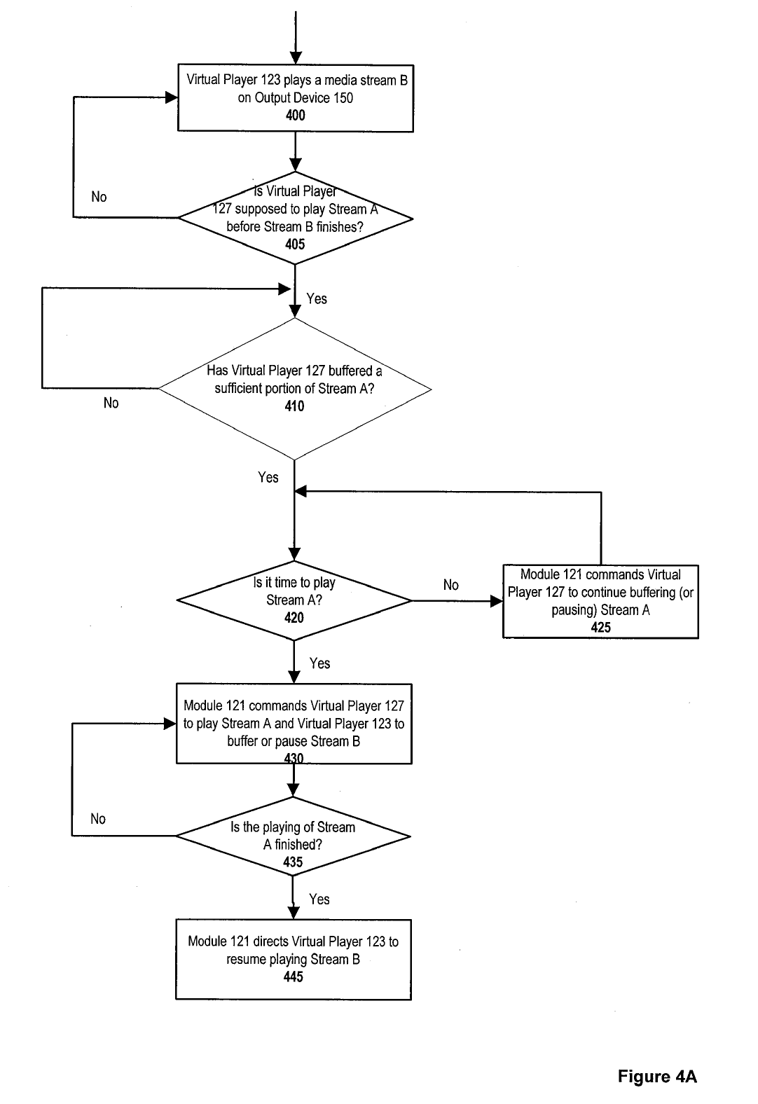

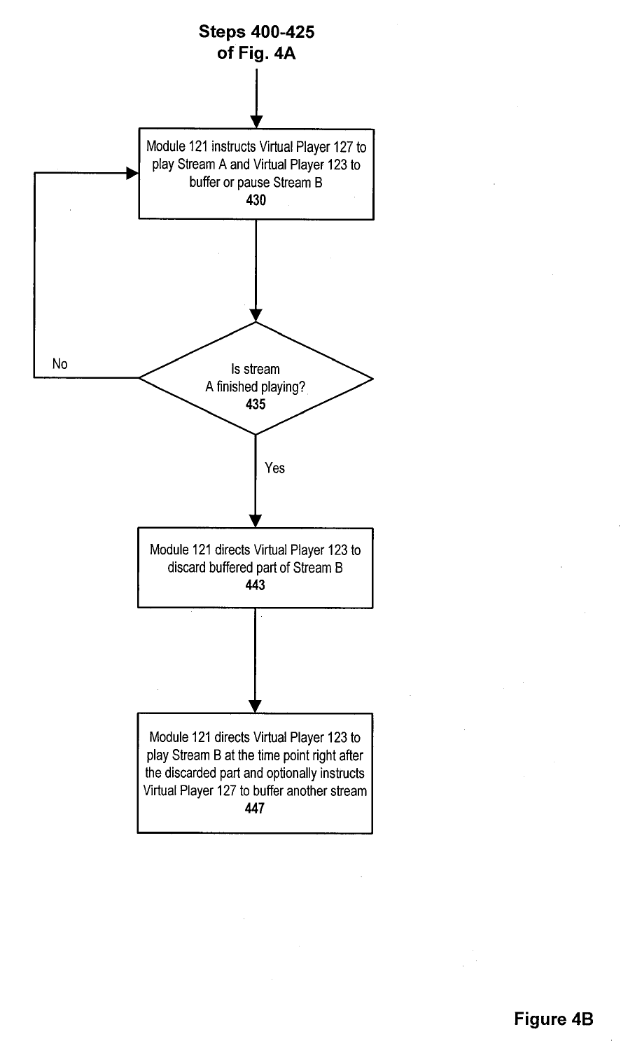

FIG. 4A illustrates a flow diagram of an exemplary process for managing multiple media streams, where two or more pre-existing media streams are played by multiple media players, according to one embodiment. This flow diagram demonstrates in detail the relationship between stream A and stream B as described in FIGS. 3A and 3B. Similar to FIGS. 3A and 3B, more than two media streams may be included in this process.

In one embodiment where media stream A (e.g., an advertisement) is intended to be inserted into currently playing media stream B (e.g., a movie or newscast), the process starts with a media player 123 playing a stream B, as shown in step 400. In step 405, module 121 determines whether media player 127 is supposed to play media stream A before media player 123 has finished playing stream B. Assuming stream A should not be played before the conclusion of stream B, module 121 directs media player 123 to continue to play stream B and steps 400 and 405 are repeated. On the other hand, if module 121 determines in step 405 that stream A should be played before the conclusion of stream B, module 121 determines in step 410 whether media player 127 has processed or buffered a sufficient amount of stream A required to begin playing stream A. If the amount of stream A buffered is insufficient to begin playing stream A, module 121 causes media player 127 to continue to buffer and process stream A, and instructs media player 123 to continue to play stream B. If stream A is sufficiently buffered in media player 127 in step 410, module 121 determines whether it is time to start playing stream A, as shown in step 420.

Because the improved system does not rely on a fixed, predetermined pre-sequenced package of media streams, the improved system may insert media stream A at any time during the playing of media stream B. Of course, the improved system may insert media stream A before or after the playing of media stream B. The improved system may dynamically determine the appropriate time to insert media stream A based on information and statistics. In one embodiment, module 121 may look at a timer or counter to determine whether it is time to start playing stream A at step 420. For example, because the time to play stream A may be predetermined (e.g., by an advertiser who wishes to play stream A or by the module 121 who manages the playing of stream A and stream B), the system may start a timer when it begins playing stream B on the display monitor and then compare the elapsed timer with the target time at which it is desired to play stream A. For instance, it may be predetermined that stream B should play for 10 minutes, then stream A should play, and then stream B should resume playing. Thus, for example, advertising may use predetermined timing so as to take advantage of statistics showing that the optimal time to play an advertisement is every fifteen minutes of streaming a movie. Alternatively, an example is to insert an advertisement at some particular point of the movie based on the development of the plot. This way, internet statistics may be used to achieve an optimal advertisement effect. As another example, the system may have a real time clock and compare the clock with the target time of day (e.g., 8:35 p.m. Pacific Standard Time) at which it is desired to play stream A. For example, stream A may be an advertisement for a television show and the advertiser desires stream A to be always shown twenty-five minutes before an episode is about to be shown on television. A counter, shift register, interrupt-driven system, or any other timing mechanism may be used. In yet another embodiment, the system does not know in advance when the stream A should be played and may determine an appropriate time to insert media stream A based on statistics that the particular user or other users are interested in media stream A.

If it is not yet time to play stream A in step 420, module 121 controls media player 127 to continue to buffer stream A, or to pause playing of stream A if stream A has already been fully buffered, and steps 420 and 425 are repeated. If it is time to play stream A, module 121 instructs media player 127 to start playing stream A and media player 123 to start buffering stream B, as shown in step 430. While stream A is being played, module 121 checks whether stream A has finished playing, as shown in step 435.

Module 121 preferably can determine the play time of a media stream and how much playing time remains. In the example where stream A is an advertisement, module 121 preferably knows in advance the predetermined playing time of stream A. In an example where stream A is a video clip, module 121 may know in advance how long the system wants to play stream A, even though stream A may be much longer. To determine whether stream A has finished playing, the system preferably started a timer upon the initial playing of stream A on the display monitor and then compares the elapsed timer with the known play time of stream A; when the elapsed timer matches the known play time of stream A, the system may presume that stream A has finished playing. Alternatively, the system may use a counter, shift register, interrupt-driven system, or any other timing mechanism. Still alternatively, the system may detect the end point of stream A or determine that processing of stream A has stopped.

If stream A is not done playing, stream A continues to be played on the display monitor and stream B is buffered (or paused), and steps 430 and 435 are repeated. If stream A is done playing, module 121 directs media player 123 to resume playing stream B (e.g., the movie) on the display monitor, in step 445. Optional buffering of other incoming media streams such as a different advertisement (stream C) will start during step 445.

In an alternative embodiment with more than two media streams, the advertiser may have created different versions of the same advertisement (e.g., based on two possible outcomes of an election or sports game). Instead of pre-packaging a particular version of the advertisement into a movie and directing the media stream towards a particular region or user, the advertiser may stream the movie and buffer different versions of the advertisement at the same time without pre-packaging. Choosing the particular version of the advertisement to be played may be determined at the last possible second, after the system has determined the optimal version to use. Alternatively, if a particular version is to be selected based on characteristics of the user or region that the user resides, this content-based determination may be based on statistics of the user's past online activities or actions that the user activated on the float layer or media stream. For example, the user may have just clicked on a float layer which suggests that this user finds an advertisement attractive or offensive. Therefore, the system allows more efficient targeting of specific users with advertisements or content. In another example, the system may monitor whether a specific user has viewed a particular advertisement, and how many times this user has viewed it. The system may determine that this particular advertisement should only be viewed by a user three times. Afterwards, a different advertisement can be shown to the user. This way, advertisers may become more efficient in targeting specific users.

FIG. 4B illustrates a flow diagram of an exemplary process for managing multiple media streams, where one or more of the media streams is live, according to one embodiment. This flow diagram demonstrates in detail the relationship between stream A and stream B as described in FIGS. 3A and 3B, in another embodiment. Similar to FIGS. 3A and 3B, more than two media streams may be included in this process.

Method steps 400 to 425 that lead to the process set forth in FIG. 4B are the same as those described in FIG. 4A. In this embodiment having two or more existing media streams, at least one of the media streams is being streamed live or in real time, e.g., a live soccer game. For example, stream B represents the live soccer game and stream A represents an advertisement or a short interview with commentators streamed at a break during the game. Initially the media player 123 plays the soccer game (stream B) on the display monitor. When it is time to play an advertisement (stream A) during a break, the media player 123 buffers stream B, while playing stream A on the display monitor. When stream A has finished playing in step 435, module 121 directs the media player 123 to resume playing live stream B on the display monitor according to the real time state of stream B, instead of resuming playing stream B from where it had left off. In the example, while the advertisement (stream A) is being played on the display monitor, the live soccer game (stream B) is being buffered in this embodiment. When the advertisement is finished playing on the display monitor, the buffered part of stream B (footage that occurred during the break) is discarded in step 443. At the same time, module 121 directs media player 123 to resume playing the soccer game (stream B) at the current real time state of the game in step 447. The footage that occurred during the break is thus omitted and not played on the display monitor. When the soccer game (stream B) is back being played, module 121 may direct media player 127 to start buffering another advertisement (stream X). In the live streaming situation, the system's flexibility in choosing which advertisement to play and when to play it is particularly important for certain applications. As a result, if unexpected developments occur during a live concert, game, or news media stream, the flexibility of the improved system permits it to dynamically insert an appropriate media stream or float layer at an appropriate time.

In the foregoing specification, the invention has been described with reference to specific embodiments thereof. It will, however, be evident that various modifications and changes may be made thereto without departing from the broader spirit and scope of the invention. For example, the reader is to understand that the specific ordering and combination of process actions described herein is merely illustrative, and the invention can be performed using different or additional process actions, or a different combination or ordering of process actions. As a further example, each feature of one embodiment can be mixed and matched with other features shown in other embodiments. Additionally and obviously, features may be added or subtracted as desired. Accordingly, the invention is not to be restricted except in light of the attached claims and their equivalents.

We claim:

1. A method of playing a plurality of media streams, the method comprising:
playing a first media stream on a monitor;
determining a desired time to play a second media stream, the second media stream being provided as a separate stream from the first media stream;
determining whether the desired time is reached; and
when the desired time is reached, playing the second media stream on the monitor while buffering the first media stream in a storage medium.

2. The method of claim 1 wherein the first media stream is a first video stream from a first source and the second media stream is a second video stream from a second source different from the first source.

3. The method of claim 2 wherein the first video stream is a real time video stream from the first source.

4. The method of claim 1 further comprising:
displaying a float layer on the first or second media stream currently being played, the float layer having an activatable portion that a user may activate to cause an event.

5. The method of claim 4 further comprising:
when a user activates the activatable portion of the float layer, the event includes interrupting the currently playing first or second media stream, buffering the interrupted media stream, and playing a third media stream on the monitor.

6. The method of claim 5 wherein the third media stream is a third video stream from a third source.

7. The method of claim 5 wherein the third video stream is an advertisement video.

8. The method of claim 4 further comprising:
when a user activates the activatable portion of the float layer, the event including interrupting the currently playing first or second media stream, buffering the interrupted media stream, and displaying a website on the monitor.

9. The method of claim 5 further comprising:
when the third media stream finishes playing, resuming the playing of the interrupted media stream at the point of interruption.

10. The method of claim 5 further comprising:
when the third media stream finishes playing, resuming the playing of the interrupted media stream at the current real time position of the interrupted media stream.

11. The method of claim 8 further comprising:
when the user exits the website, resuming the playing of the interrupted media stream at the point of interruption.

12. The method of claim 8 further comprising:
when the user exits the website, resuming the playing of the interrupted media stream at the current real time position of the interrupted media stream.

13. The method of claim 1 wherein the step of determining a desired time to play a second media stream includes receiving a desired elapsed time of the playing of the first media stream at which the second media stream should begin playing.

14. The method of claim 13 wherein the step of determining whether the desired time is reached includes monitoring an elapsed time of the playing of the first media stream and comparing the elapsed time with the desired elapsed time.

15. The method of claim 4 wherein the activatable portion of the float layer is activatable by the user's movement of a cursor over the portion.

16. The method of claim 4 wherein the activatable portion of the float layer is activatable by the user's selection of the portion with a mouse, trackball, or touchpad.

17. The method of claim 4 wherein the float layer has a plurality of activatable portions.

18. The method of claim 4 further comprising monitoring a usage statistic of the user's activation or non-activation of the activatable portion.

19. The method of claim 18 further comprising using the usage statistic of the activatable portion to affect whether the same activatable portion is displayed to the user in the future.

20. The method of claim 18 further comprising using the usage statistic of the activatable portion to change the event caused by the activatable portion to a different event.

21. An apparatus for playing a plurality of media streams, the apparatus comprising:
a display monitor;
a media processor adapted to play a first media stream on the display monitor;
a timer to determine whether it is time to play a second media stream on the display monitor, the second media stream being provided as a separate stream from the first media stream; and
a storage medium to buffer the first media stream when the desired time is reached so the media processor can play the second media stream on the display monitor.

22. The apparatus of claim 21 wherein the first media stream is a first video stream from a first source and the second media stream is a second video stream from a second source different from the first source.

23. The apparatus of claim 22 wherein the first video stream is a real time video stream from the first source.

24. The apparatus of claim 21 wherein the media processor is adapted to display a float layer on the first or second media stream currently being played, the float layer having an activatable portion that a user may activate to cause an event.

25. The apparatus of claim 24 wherein activation of the activatable portion causes the media processor to interrupt the currently playing first or second media stream, buffer the interrupted media stream, and play a third media stream on the monitor.

26. The apparatus of claim 25 wherein the third media stream is a third video stream from a third source.

27. The apparatus of claim 25 wherein the third video stream is an advertisement video.

28. The apparatus of claim 24 wherein activation of the activatable portion causes the media processor to interrupt the currently playing first or second media stream, buffer the interrupted media stream, and display a website on the monitor.

29. The apparatus of claim 25 wherein after the media processor finishes playing the third media stream, the media processor resumes the playing of the interrupted media stream at the point of interruption.

30. The apparatus of claim 25 wherein after the media processor finishes playing the third media stream, the media processor resumes the playing of the interrupted media stream at the current real time position of the interrupted media stream.

31. The apparatus of claim 28 wherein the media processor detects when the user exits the website and upon the detection of the user's exiting of the website, the media processor resumes the playing of the interrupted media stream at the point of interruption.

32. The apparatus of claim 28 wherein the media processor detects when the user exits the website and upon the detection of the user's exiting of the website, the media processor resumes the playing of the interrupted media stream at the current real time position of the interrupted media stream.

33. The apparatus of claim 21 wherein the timer receives a desired elapsed time of the playing of the first media stream at which the second media stream should begin playing.

34. The apparatus of claim 33 wherein the timer monitors an elapsed time of the playing of the first media stream and compares the elapsed time with the desired elapsed time.

35. The apparatus of claim 24 further comprising a cursor on the monitor that activates the activatable portion of the float layer when the cursor is placed over the activatable portion.

36. The apparatus of claim 24 further comprising a mouse, trackball, or touchpad adapted to permit the user to activate the activatable portion of the float layer.

37. The apparatus of claim 24 wherein the float layer has a plurality of activatable portions.

38. The apparatus of claim 24 wherein the media processor monitors a usage statistic of the user's activation or non-activation of the activatable portion.

39. The apparatus of claim 38 wherein the media processor uses the usage statistic of the activatable portion to affect whether the same activatable portion is displayed to the user in the future.

40. The apparatus of claim 38 wherein the media processor uses the usage statistic of the activatable portion to change the event caused by the activatable portion to a different event.
